(19) United States
(12) Patent Application Publication
(10) Pub. No.: US 2008/0193155 A1
(43) Pub. Date: Aug. 14, 2008

(54) IMAGE FORMING APPARATUS AND METHOD OF CONTROLLING A TEMPERATURE OF A FIXING UNIT THEREOF

(75) Inventor: Ji-young BYUN, Bucheon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/014,247

(22) Filed: Jan. 15, 2008

(30) Foreign Application Priority Data
Feb. 13, 2007 (KR) 10-2007-0015065

(51) Int. Cl. G03G 15/20

(52) U.S. Cl. 399/69; 399/70

(57) ABSTRACT

An image forming apparatus includes an image forming unit to form an image, a fixing unit to fix the image which is formed by the image forming unit onto a printing medium, a power supply unit to supply electric power to the fixing unit, a first fixing unit control part to control the power supply unit to supply electric power to the fixing unit if initialization of the image forming unit is ended, and a second fixing unit control part to control the power supply unit to supply electric power to the fixing unit while the initialization is performed by the first fixing unit control part.

### CROSS-REFERENCE TO RELATED APPLICATIONS

This application claims priority under 35 U.S.C. §119(a) from Korean Patent Application No. 10-2007-0015065, filed on Feb. 13, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus and a method of controlling a temperature of a fixing unit thereof, and more particularly, to an image forming apparatus which supplies electric power to a fixing unit and a method of controlling a temperature of the fixing unit thereof.

2. Description of the Related Art

A conventional image forming apparatus forms a predetermined image based on printing data. As illustrated in FIG. 1, a conventional image forming apparatus achieves image formation, which includes a photosensitive medium 11, an electrifier 12 which electrifies the photosensitive medium 11 in uniform electric potential, an exposure unit 13 which scans light corresponding to printing data to the photosensitive medium 11 and forms an electrostatic latent image, a developing unit 14 which includes a developer and deposits the developer on the electrostatic latent image formed to the electrified photosensitive medium 11, and a transfer unit 15 which transfers a toner developed on the electrified photosensitive medium 11 to a printing medium using a transfer belt 16.

Meanwhile, an image formed onto a printing medium is thermally pressed by a fixing unit 20 to then be output to the outside. The fixing unit 20 includes a heat roller 22 which is heated up to the temperature of about 200°, and also includes a pressing roller 24 to press an image onto a printing medium.

In a conventional image forming apparatus, if electric power is supplied from the outside, a fixing unit temperature control circuit confirms whether an image forming unit 10 is out of order. Thus, electric power is supplied to the fixing unit 20 after initialization is ended. Accordingly, since image can be printed on a printing medium after both of the initialization of the image forming unit 10 and warming-up of the fixing unit 20 are ended, a user's standby time is undesirably prolonged.

### SUMMARY OF THE INVENTION

The present general inventive concept provides an image forming apparatus and controlling a temperature of a fixing unit thereof, which supplies electric power to the fixing unit together with initialization of an image forming unit, to thereby minimize a standby time of printing on a printing medium.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an image forming apparatus including an image forming unit to form an image, a fixing unit to fix the image which is formed by the image forming unit and transferred on a printing medium, a power supply unit to supply electric power to the fixing unit, a first fixing unit control part to control the power supply unit to supply electric power to the fixing unit if initialization of the image forming unit is ended, and a second fixing unit control part to control the power supply unit to supply electric power to the fixing unit while the initialization is performed by the first fixing unit control part.

The second fixing unit control part may control the power supply unit to supply electric power to the fixing unit if an external electric power is applied.

The second fixing unit control part may discontinue control of the power supply unit if the initialization of the image forming unit is ended.

The second fixing unit control part may further include a comparator to compare a highest electric power level which is permitted to the fixing unit with an electric power level which is supplied to the fixing unit, to thus control the power supply unit to cut off the electric power supplied to the fixing unit if the supplied electric power level is higher than the highest electric power level according to the comparison result.

The fixing unit may fix the transferred image on the printing medium by radiant heat generated from a halogen lamp.

The foregoing and/or other aspects and utilities of the present general inventive concept can also be achieved by providing a temperature control method of a fixing unit in an image forming apparatus including an image forming unit which forms an image and the fixing unit which fixes the image which is formed by the image forming unit and transferred on a printing medium, the temperature control method including performing an initializing operation corresponding to the image forming unit, and supplying electric power to the fixing unit while the initialization is performed.

The supplying of electric power to the fixing unit may include supplying electric power to the fixing unit if an external electric power is applied.

The supplying of the electric power to the fixing unit may further include discontinuing control of the electric power to be supplied to the fixing unit in the case that initialization of the image forming unit is ended.

The supplying of the electric power to the fixing unit further includes comparing a highest electric power level which is permitted to the fixing unit with an electric power level which is supplied to the fixing unit, and cutting off the electric power supplied to the fixing unit if the supplied electric power level is higher than the highest electric power level.

The fixing unit may perform the fixing by radiant heat generated from a halogen lamp.

The foregoing and/or other aspects and utilities of the present general inventive concept can also be achieved by providing a fixing unit control part to control temperature of a fixing unit of an image forming apparatus, the fixing unit control part comprising a temperature sensor to sense the temperature of the fixing unit, a first control circuit to control the fixing unit to generate heat during an initialization of the image forming apparatus, and a second control circuit to control the fixing unit to generate heat during the initialization of the image forming apparatus wherein the first control circuit controls the second control circuit to cut off power supplied to the fixing unit based on a comparison between the temperature sensed by the temperature sensor and a predetermined reference temperature.

The initialization may start upon receipt of an external power or a command to perform printing in the image forming apparatus.

The first control part may comprise a controller to control the fixing unit to emit heat based on the comparison between the temperature of the fixing unit and the predetermined reference temperature.

The controller may cut off power supplied to the fixing unit when the temperature sensed by the temperature sensor is greater than the predetermined reference temperature.

The controller may cut off power supplied to the second control unit when the temperature sensed by the temperature sensor is greater than the predetermined reference temperature.

The foregoing and/or other aspects and utilities of the present general inventive concept can also be achieved by providing an image forming apparatus, comprising an image forming unit to form an image to be transferred onto a printing medium, a fixing unit to fix the image onto the printing medium, a temperature sensor to sense a temperature of the fixing unit, and a plurality of fixing unit control parts to selectively supply power to the fixing unit based on a comparison between the temperature of the fixing unit and a predetermined reference temperature and one of initialization and printing of the image forming unit.

The at least two of the plurality of fixing unit control parts may supply power to the fixing unit during the initialization of the image forming apparatus.

The at least one of the plurality of fixing unit control parts may control at least another one of the plurality of fixing unit control parts to stop supplying power to the fixing unit based on the comparison between the temperature of the fixing unit and the predetermined reference temperature.

The supply of power may be stopped when the temperature of the fixing unit exceeds the predetermined reference temperature.

The plurality of fixing unit control parts may selectively supply power to the fixing unit if a temperature of the fixing unit is below the predetermined reference temperature.

Each of the plurality of fixing unit control parts may comprise a comparator to compare the temperature of the fixing unit to the predetermined reference temperature.

At least one of the plurality of fixing unit control parts may comprise a comparator to compare the temperature of the fixing unit to the reference temperature, and a circuit to determine whether the power is supplied to the fixing unit.

The foregoing and/or other aspects and utilities of the present general inventive concept can also be achieved by providing a method of controlling temperature of a fixing unit of an image forming apparatus, the method comprising sensing the temperature of the fixing unit, controlling the fixing unit to generate heat during an initialization of the image forming apparatus with a first control circuit, controlling the fixing unit to generate heat during the initialization of the image forming apparatus with a second control circuit, wherein the first control circuit controls the second control circuit to cut off power supplied to the fixing unit based on a comparison between the sensed temperature sensed and a predetermined reference temperature.

The initialization may start upon receipt of an external power or a command to perform printing in the image forming apparatus.

The method may further comprise cutting off power supplied to the fixing unit when the sensed temperature is greater than the predetermined reference temperature.

The method may further comprise cutting off power supplied to the second control unit when the sensed temperature is greater than the predetermined reference temperature.

The foregoing and/or other aspects and utilities of the present general inventive concept can also be achieved by providing a method of an image forming apparatus, comprising forming an electrostatic latent image on a printing medium, sensing a temperature of a fixing unit, selectively supplying power to the fixing unit based on a comparison between the temperature of the fixing unit and a predetermined reference temperature and one of initialization and printing of the image forming apparatus, and fixing the electrostatic latent image onto the printing medium.

The method may further comprise selectively supplying power to the fixing unit if a temperature of the fixing unit is below the predetermined reference temperature.

The selectively supplying power to the fixing unit may be performed by a plurality of fixing unit control parts.

The method may further comprise supplying power to the fixing unit during the initialization of the image forming apparatus using at least two of the plurality of fixing unit control parts.

The method may further comprise selectively controlling at least one of the plurality of fixing unit control parts to stop supplying power to the fixing unit based on the comparison between the temperature of the fixing unit and the predetermined reference temperature.

The supply of power may be stopped when the temperature of the fixing unit exceeds the predetermined reference temperature.

### BRIEF DESCRIPTION OF THE DRAWINGS

These and/or other aspects and utilities of the present general inventive concept will become apparent and more readily appreciated from the following description of the embodiments, taken in conjunction with the accompanying drawings in which:

FIG. 1 is a diagram schematically illustrating structure of a conventional image forming apparatus;

FIG. 2 is a block diagram illustrating a configuration of an image forming apparatus according to an exemplary embodiment of the present general inventive concept;

FIG. 3 is a circuit diagram illustrating a fixing unit control part of an image forming apparatus according to an exemplary embodiment of the present general inventive concept; and

FIG. 4 is a flowchart illustrating a fixing unit control method of an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

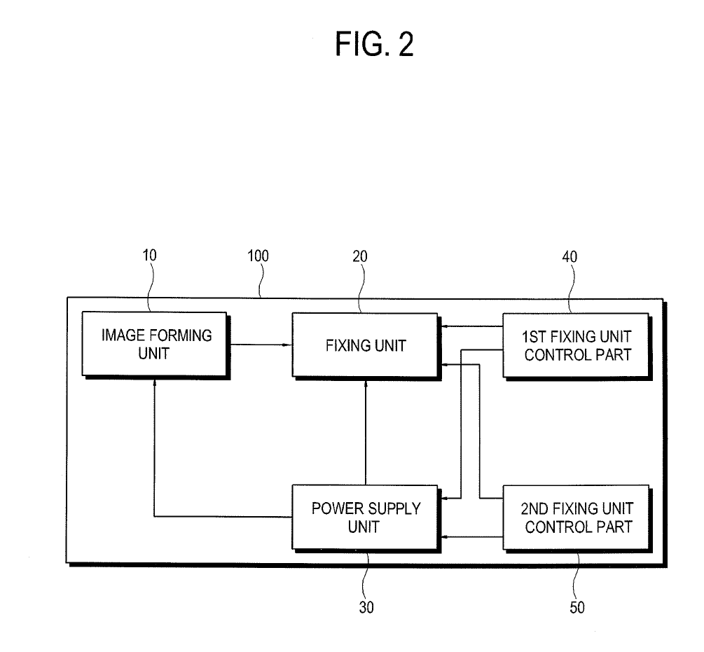

FIG. 2 is a block diagram illustrating a configuration of an image forming apparatus 100 according to an embodiment of the present general inventive concept. As illustrated in FIG. 2, the image forming apparatus 100 according to an embodiment of the present general inventive concept includes an image forming unit 10, a fixing unit 20, a power supply unit 30, a first fixing unit control part 40 and a second fixing unit control part 50, and is implemented in an electrophotographic printing device.

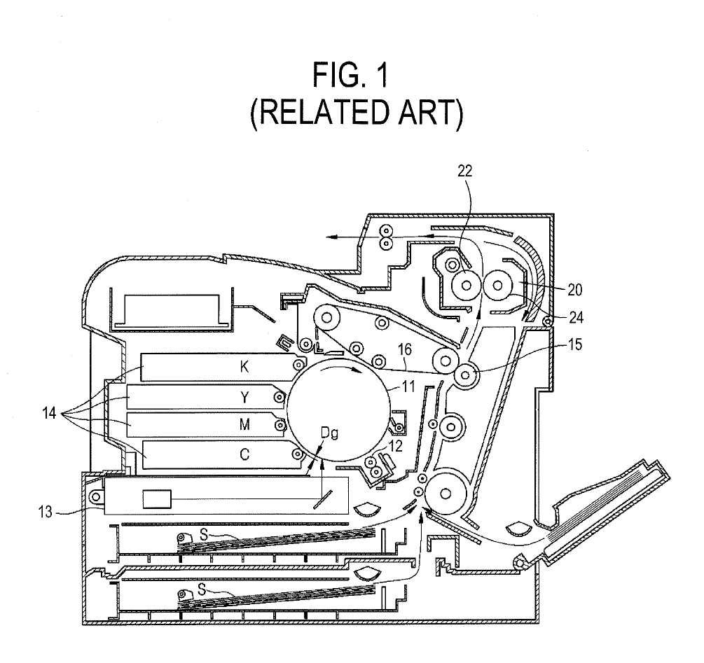

The image forming apparatus 100 of FIG. 2 may have a similar structure to the conventional image forming apparatus of FIG. 1. The image forming unit 10 forms an image based on printing data. The image forming unit 10 according to an embodiment of the present general inventive concept includes a photosensitive medium 11, an electrifying unit 12, an exposure unit 13, a developing unit 14 and a transfer unit 15.

The photosensitive medium 11 forms an electrostatic latent image based on printing data. The electrifying unit 12 electrifies the photosensitive medium 11 in a predetermined electric potential. The exposure unit 13 scans light on photosensitive medium 11, to form the electrostatic latent image. The developing unit 14 supplies toner to the photosensitive medium 11, on which the electrostatic latent image has been formed, to form a visible image. The printing medium passes between the photosensitive medium 11 and the transfer unit 15 by a conveying (or transfer) belt 16. Accordingly, the visible image which has been developed on the photosensitive medium 11 is transferred to the printing medium surface facing the photosensitive medium 11.

The image which has been formed by the image forming unit 10 and transferred on the printing medium is fixed on the printing medium by the fixing unit 20 through thermal pressing. The fixing unit 20 according to the present general inventive concept includes a heat roller 22 including a heater (not illustrated) therein to emit heat, and a pressing roller 24 which contacts the heat roller 22 to form a fixing nip. The heat roller 22 and the pressing roller 24 rotate in engagement with each other at a predetermined pressure, to apply heat and pressure to the image formed by the image forming unit 10 to thereby fix the image on the printing medium. A heating unit which generates heat may be provided in at least one of the heat roller 22 and the pressing roller 24.

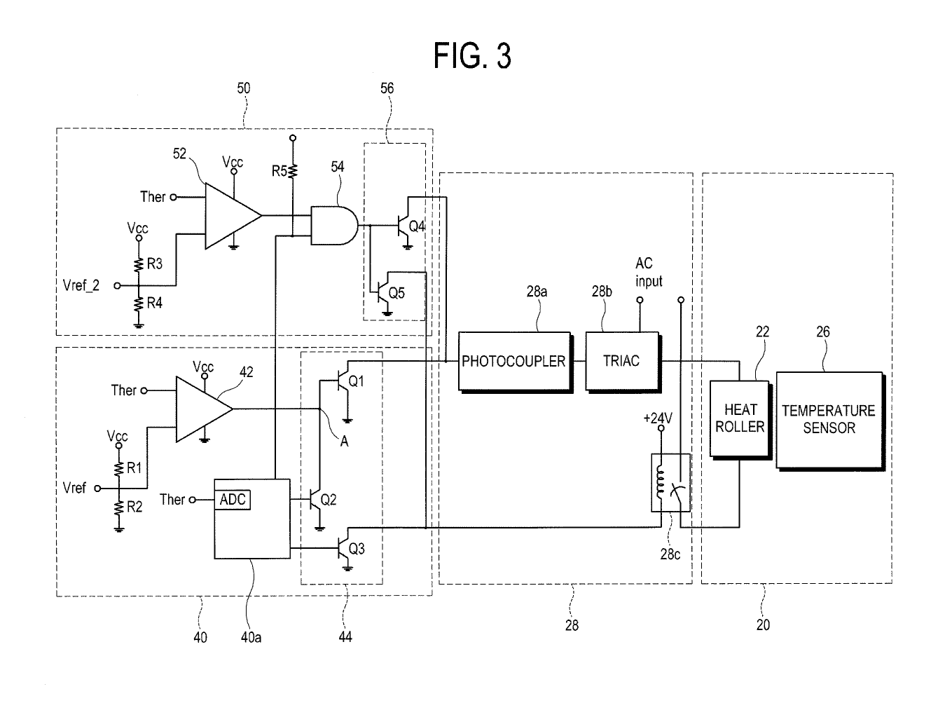

Referring to FIGS. 2 and 3, the fixing unit 20 includes a temperature sensor 26 which measures temperature on one or more outer circumferential surfaces of the heat roller 22 and/or the pressing roller 24, and a fixing unit controller 28 which controls temperature or an amount of heat radiation of the heat roller 22 according to the temperature measured by the temperature sensor 26.

The heater included in the heat roller 22 may be implemented as one of a halogen lamp, a heat wire and an induction heater, and the temperature sensor 26 may be embodied as a thermistor having a feature of a relatively large resistance change even with a small temperature change.

In addition, the fixing unit controller 28 includes a photocoupler 28a which transfers an output signal output from the first fixing control part 40 and/or the second fixing control part 50, a Triac 28b, which is turned on when an output signal corresponding to the turn-on signal is transmitted from the photocoupler 28a, and transmits an alternating-current (AC) power to the heat roller 22 of the fixing unit 20, and a relay 28c which controls power supplied to the heat roller 22.

The power supply unit 30 supplies electric power to the fixing unit 20. The power supply unit 30 according to an embodiment of the present general inventive concept supplies electric power to the heat roller 22 of the fixing unit 20, by a Pulse Width Modulation (PWM) method. The power supply unit 30 may also include a High Voltage Power Supply (HVPS) which applies high tension electric power to the image forming unit 10.

The first fixing unit control part 40 controls the power supply unit 30 to supply electric power to the fixing unit 20 during and after initialization of the image forming unit 10, and includes a comparator 42 which compares the temperature of the fixing unit 20, which is sensed by the temperature sensor 26, with a predetermined highest temperature according to heat radiation of the fixing unit 20, and a transistor block 44 including transistors Q1, Q2, and Q3. Here, the initialization of the image forming apparatus 100 may include initialization of an HDD (not illustrated) that stores, for example, image data to correspond to the electrostatic latent image, as well as heating of the fixing unit 20. Accordingly, printing is performed after the initialization, and includes the actual transfer of the toner onto the printing medium and a subsequent fixing of the toner by the fixing unit 20 onto the printing medium.

Hereinbelow, operation of the first fixing unit control part 40 will be described in detail with reference to FIG. 3. FIG. 3 is a circuit diagram illustrating a fixing unit control part of the image forming apparatus 100 according to an embodiment of the present general inventive concept.

As illustrated in FIG. 3, the first fixing unit control part 40 turns on the transistor Q3 during the initialization or when the printing starts if the temperature of the fixing unit 20, which is sensed by the temperature sensor 26, is lower than the predetermined highest temperature according to the heat radiation of the fixing unit 20. The first fixing unit control part 40 includes a controller 40a which reads the temperature sensed by the temperature and outputs a signal to turn on either the transistor Q2 or the transistor Q3. If the temperature sensed by the temperature sensor 26 is higher than the predetermined highest temperature according to the heat radiation of the fixing unit 20, then the transistor Q2 is turned on. In contrast, if the temperature sensed by the temperature sensor 26 is lower than the predetermined highest temperature according to the heat radiation of the fixing unit 20, then the transistor Q3 is turned on. When the transistor Q3 is turned on, a relay 28c of the fixing unit controller 28 is also turned on, and thus an alternating current (AC) power is applied to the fixing unit 20. The transistor Q2 and the transistor Q3 are never on simultaneously. The comparator 42 included in the first fixing unit control part 40 compares the temperature of the fixing unit 20 that is sensed by the temperature sensor 26 with the predetermined highest temperature according to the heat radiation of the fixing unit 20, and outputs a high-level signal when the sensed temperature of the fixing unit 20 is lower than the predetermined highest temperature according to the heat radiation of the fixing unit 20, that is, when an electric potential corresponding to the highest temperature is lower than the electric potential of the temperature sensor 26. Accordingly, an electric potential level of a point “A” becomes high and the transistor Q1 is turned on. As a result, the photocoupler 28a of the fixing unit controller 28 is turned on and the Triac is turned on so that the alternating current (AC) power is applied to the heat roller 22 of the fixing unit 20, to thus emit heat.

In contrast, the comparator 42 outputs a low-level signal when the sensed temperature of the fixing unit 20 is higher than the predetermined highest temperature according to the heat radiation of the fixing unit 20, that is, when an electric potential corresponding to the highest temperature is higher than the electric potential of the temperature sensor 26.

If the low-level signal is output from the comparator 42, the electric potential level of a point “A” becomes low, and the transistor Q1 opens. Thus, the photocoupler 28a of the fixing unit controller 28 opens, and the Triac 28b is turned off. As a result, power supply to the heat roller 22 of the fixing unit 20 is cut off.

In addition, if the controller 40a senses that the temperature of the fixing unit 20 is continuously ascending according to an electric potential level of the temperature sensor 26 included in the fixing unit 20, the first fixing unit control part 40 opens the transistor Q3, to thereby turn off the relay 28c included in the fixing unit controller 28 to abruptly interrupt electric power being supplied to the fixing unit 20.

The second fixing unit control part 50 controls the power supply unit 30 to supply electric power to the fixing unit 20 while the first fixing unit control part 40 performs initialization. The second fixing unit control part 50, according to an embodiment of the present general inventive concept, includes a comparator 52 which compares the temperature of the fixing unit 20 that is sensed by the temperature sensor 26 with a reference temperature, an AND circuit 54 which determines whether electric power is supplied to the fixing unit 20 according to whether electric power is supplied to the image forming unit 10, and a transistor block 56 including transistors Q4 and Q5, whose powered states are determined according to an output of the AND circuit 54.

The second fixing unit control part 50, according to an embodiment of the present general inventive concept, will be described in detail with reference to FIG. 3. If an external power is applied to the image forming apparatus 100, an output signal becomes a high level through a resistor R5, and thus a level of an output signal of the AND circuit 54, which is dependent upon a level of an output signal from the comparator 52, is determined.

Accordingly, if the temperature of the fixing unit 20 at a time when the external power is applied to the image forming apparatus 100 is lower than the highest temperature according to heat radiation of the fixing unit 20, the electric potential of the temperature sensor 26 included in the fixing unit 20 is higher than that corresponding to the predetermined highest temperature according to the heat radiation of the fixing unit 20. Therefore, the level of the output signal from the comparator 52 becomes high, and the level of the output signal of the AND circuit 54 becomes also high.

Since the output signal of the AND circuit 54 is high, transistors Q4 and Q5 are both turned on and the photocoupler 28a, which is included in the fixing unit controller 28, is turned on irrespective of initialization of the image forming unit 10. As a result, the Triac 28b is turned on and thus the heat roller 22 is heated.

However, when the temperature of the fixing unit 20 reaches the predetermined highest temperature according to the heat radiation of the fixing unit 20, that is, the electric potential of the temperature sensor 26 included in the fixing unit 20 is lower than that corresponding to the predetermined highest temperature according to the heat radiation of the fixing unit 20, the level of the output signal from the comparator 52 included in the second fixing unit control part 50 becomes low, and thus the level of the output signal from the AND circuit 54 also becomes low.

Accordingly, the transistors Q4 and Q5 open, and the photocoupler 28a included in the fixing unit controller 28 is turned off to thereby open the Triac 28b and the relay 28c to cut off heat radiation of the heat roller 22.

Even if the AND circuit 54 of the second fixing unit control part 50 receives the low-level output signal from the controller 40a of the first fixing unit control part 40 when the level of the output signal from the comparator 52 is high, the transistors Q4 and Q5 open to interrupt heat radiation of the heat roller 22.

Therefore, when the initialization of the image forming unit 10 ends, the first fixing unit control part 40 applies the low-level output signal to the second fixing unit control part 50 to open the transistors Q4 and Q5. Accordingly, the power can be prevented from being overlappingly supplied to the fixing unit 20.

Accordingly, the second fixing unit control part 50 can supply electric power to the fixing unit 20 during initialization of the image forming unit 10 only when the temperature of the fixing unit 20 that is sensed by the temperature sensor 26 is not higher than a predetermined value (i.e., the predetermined highest temperature according to the heat radiation of the fixing unit 20).

For example, since electric power is initially supplied to the fixing unit 20 when the electric power is initially supplied to the image forming apparatus 100, the temperature of the fixing unit 20 is lower in comparison to when the electric power has been previously applied to the fixing unit 20 to perform the fixing operation. Further, it takes a lot of time to reach temperature necessary to fix an image on a printing medium. In particular, it takes a lot of time to emit heat at a certain temperature when a heater equipped in the heat roller 22 of the fixing unit 20 is implemented by a halogen lamp.

Therefore, when the temperature of the fixing unit 20 is not higher than a predetermined value (i.e., the predetermined highest temperature according to the heat radiation of the fixing unit 20), the second fixing unit control part 50 supplies electric power to the fixing unit 20 while the initialization of the image forming unit 10 is executed, to thereby reduce a user's standby time.

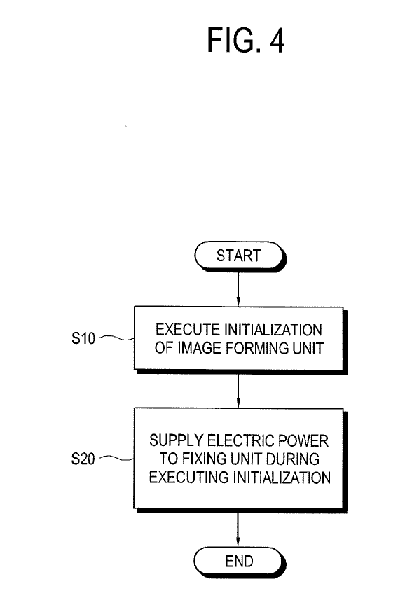

Hereinbelow, a fixing unit temperature control method of the image forming apparatus 100 according to an embodiment of the present general inventive concept will be described with reference to FIG. 4.

In operation S10, the first fixing unit control part 40 performs an initialization operation of the image forming unit 10.

In operation S20, the second fixing unit control part 50 supplies electric power to the fixing unit 20 while the first fixing unit control part 40 executes the initialization of the image forming unit 10 in operation S10. Accordingly, in operation S20, electric power can be supplied to the fixing unit 20 when an external power is applied to the image forming apparatus 100. Further, in operation S20, the electric power may be supplied to the fixing unit 20 if the temperature of the fixing unit 20 is not higher than a predetermined value (i.e., the predetermined highest temperature according to the heat radiation of the fixing unit 20), such as when an external power is initially applied to the image forming apparatus 100.

In addition, operation S20 may further include an operation of cutting off supplying of electric power to the fixing unit 20 when the initialization of the image forming unit 10 ends. Accordingly, the electric power can be prevented from being overlappingly supplied to the fixing unit 20.

Also, operation S20 may further include the operations of comparing the highest electric power level which is permitted to the fixing unit 20 with the electric power level which is supplied to the fixing unit 20 according to the temperature that is sensed by the temperature sensor 26, and blocking electric power supply to the fixing unit 20 when the electric power level that is supplied to the fixing unit 20 is larger than the highest electric power level in the fixing unit 20, according to the comparison result. Accordingly, the anti power-overlapping function of the fixing unit 20 can be executed.

As described above, the present general inventive concept provides an image forming apparatus and a method of controlling a temperature of a fixing unit thereof, in which electric power is supplied to a fixing unit while an image forming unit is initialized, to thereby minimize a user's standby time of printing on a printing medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
an image forming unit to form an image;
a fixing unit to fix the image formed by the image forming unit onto a printing medium;
a power supply unit to supply electric power to the fixing unit;
a first fixing unit control part to control the power supply unit to supply electric power to the fixing unit if initialization of the image forming unit ends; and
a second fixing unit control part to control the power supply unit to supply electric power to the fixing unit while the initialization is performed by the first fixing unit control part.

2. The image forming apparatus according to claim 1, wherein the second fixing unit control part controls the power supply unit to supply electric power to the fixing unit if an external electric power is applied.

3. The image forming apparatus according to claim 1, wherein the second fixing unit control part discontinues control of the power supply unit if the initialization of the image forming unit is ended.

4. The image forming apparatus according to claim 1, wherein the second fixing unit control part further comprises:
a comparator to compare a highest electric power level which is permitted to the fixing unit with an electric power level supplied to the fixing unit, to control the power supply unit to cut off the electric power supplied to the fixing unit if the supplied electric power level is higher than the highest electric power level according to the comparison result.

5. An image forming apparatus, comprising:
an image forming unit to form an image to be transferred onto a printing medium;
a fixing unit to fix the image onto the printing medium;
a temperature sensor to sense a temperature of the fixing unit; and
a plurality of fixing unit control parts to selectively supply power to the fixing unit based on a comparison between the temperature of the fixing unit and a predetermined reference temperature and one of initialization and printing of the image forming unit.

6. The image forming apparatus of claim 5, wherein at least two of the plurality of fixing unit control parts supply power to the fixing unit during the initialization of the image forming unit.

7. The image forming apparatus of claim 5, wherein at least one of the plurality of fixing unit control parts controls at least another one of the plurality of fixing unit control parts to stop supplying power to the fixing unit based on the comparison between the temperature of the fixing unit and the predetermined reference temperature.

8. The image forming apparatus of claim 7, wherein the supply of power is stopped when the temperature of the fixing unit exceeds the predetermined reference temperature.

9. The image forming apparatus of claim 5, wherein the plurality of fixing unit control parts selectively supply power to the fixing unit if a temperature of the fixing unit is below the predetermined reference temperature.

10. The image forming apparatus of claim 9, wherein each of the plurality of fixing unit control parts comprises:
a comparator to compare the temperature of the fixing unit to the predetermined reference temperature.

11. The image forming apparatus of claim 9, wherein at least one of the plurality of fixing unit control parts comprises:
a comparator to compare the temperature of the fixing unit to the reference temperature; and
a circuit to determine whether the power is supplied to the fixing unit.

12. A method of controlling temperature of a fixing unit of an image forming apparatus, the method comprising:
sensing the temperature of the fixing unit;
controlling the fixing unit to generate heat during an initialization of the image forming apparatus with a first control circuit; and
controlling the fixing unit to generate heat during the initialization of the image forming apparatus with a second control circuit,
wherein the first control circuit controls the second control circuit to cut off power supplied to the fixing unit based on a comparison between the sensed temperature sensed and a predetermined reference temperature.

13. The method of claim 12, wherein the initialization starts upon receipt of an external power or a command to perform printing in the image forming apparatus.

14. The method of claim 12, further comprising:
cutting off power supplied to the fixing unit when the sensed temperature is greater than the predetermined reference temperature.

15. The method of claim 12, further comprising:
cutting off power supplied to the second control unit when the sensed temperature is greater than the predetermined reference temperature.

16. A method of an image forming apparatus, comprising:
forming an electrostatic latent image on a printing medium;
sensing a temperature of a fixing unit;
selectively supplying power to the fixing unit based on a comparison between the temperature of the fixing unit and a predetermined reference temperature and one of initialization and printing of the image forming unit and one of initialization and printing of the image forming apparatus; and
fixing the electrostatic latent image onto the printing medium.

17. The method of claim 16, further comprising:
selectively supplying power to the fixing unit if a temperature of the fixing unit is below the predetermined reference temperature.

18. The method of claim 16, wherein the selectively supplying power to the fixing unit is performed by a plurality of fixing unit control parts.

19. The method of claim 18, further comprising:
supplying power to the fixing unit during the initialization of the image forming apparatus using at least two of the plurality of fixing unit control parts.

20. The method of claim 18, further comprising:
selectively controlling at least one of the plurality of fixing unit control parts to stop supplying power to the fixing unit based on the comparison between the temperature of the fixing unit and the predetermined reference temperature.
